(19) United States
(12) Patent Application Publication
(10) Pub. No.: US 2006/0215203 A1
(43) Pub. Date: Sep. 28, 2006

(54) Data storage output apparatus and method, and data processing apparatus and method

(75) Inventors: Kazuman Taniuchi, Kanagawa (JP); Masayuki Hisatake, Kanagawa (JP); Yuzuru Suzuki, Kanagawa (JP); Takeshi Furuya, Kanagawa (JP); Yutaka Koshi, Kanagawa (JP); Tadaomi Suzuki, Kanagawa (JP); Yoshihiro Terada, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/384,351

(22) Filed: Mar. 21, 2006

(30) Foreign Application Priority Data
Mar. 25, 2005 (JP) 2005-090103

(51) Int. Cl. G06F 3/12

(52) U.S. Cl. 358/1.13; 358/1.15

(57) ABSTRACT

This invention provides a data storage output apparatus that includes an input component, plural output components, a storage component and a conversion component. The input component inputs data. The plural output components output data in different respective data formats. The storage component stores data in an intermediate format, which can be converted to data formats required by the respective plural output components. The conversion component converts the data stored in the storage component to a data format corresponding to the output component and outputs the data to the output component.

### CROSS-REFERENCE TO RELATED APPLICATION

This application claims priority under 35USC119 from Japanese Patent Application No. 2005-090103, the disclosure of which is incorporated by reference herein.

### BACKGROUND

1. Technical Field

The present invention relates to a data storage output apparatus and method and data processing apparatus and method, and more particularly to a data storage output apparatus and method for outputting inputted data in a predetermined format and a data processing apparatus and method for processing the inputted data.

2. Related Art

Conventionally, a multi-function printer capable of executing multiple functions including scanning, copying, printing, facsimile sending/receiving, data receiving from a personal computer, reading from a medium and the like has been proposed. Such a multi-function printer can improve image quality and productivity by optimizing the data format for executing each function for each image path.

However, because the data format for executing each function is optimized for each image path, and each input portion such as scanning portion, receiving portion only has a path reaching a print output portion, data obtained for executing one certain function cannot be executed with another function. Therefore, for example, data obtained for copying cannot be sent through a facsimile.

### SUMMARY

The present invention has been made in views of the above circumstances and provides a data storage output apparatus and method and data processing apparatus and method.

According to an aspect of the present invention, a data storage output apparatus has an input component, a plurality of output components, a storage component and a conversion component. The input component inputs data. The plurality of output components output data in different respective data formats. The storage component stores data in an intermediate format capable of being converted to a data format required by each of the plurality of output components. The conversion component converts the data stored in the storage component to a data format corresponding to an output component and outputs the data to the output component.

### BRIEF DESCRIPTION OF THE DRAWINGS

Embodiments of the present invention will be described in detail based on the following figures, wherein:

FIGS. 1A to 1C are block diagrams of a multi function printer according to an exemplary embodiment of the present invention;

FIG. 2 is a block diagram showing a path from a receiving portion, for receiving data from a client, to an image output unit;

FIG. 3 is a block diagram showing a modification of a path from the receiving portion, for receiving data from the client, to the image output unit;

FIG. 4 is a block diagram showing a path from an image reading unit 24 to the image output unit;

FIG. 5 is a block diagram showing a modification of a path from the image reading unit 24 to the image output unit;

FIGS. 6A to 6C are block diagrams showing data flow from each input portion to a first memory area and a second memory area;

FIG. 7 is a block diagram showing data flow between the first memory area and the second memory area; and

FIG. 8 is a block diagram showing data flow from the first memory area and the second memory area to each output portion.

### DETAILED DESCRIPTION

Hereinafter, embodiments of the present invention will be described in detail with reference to the accompanying drawings.

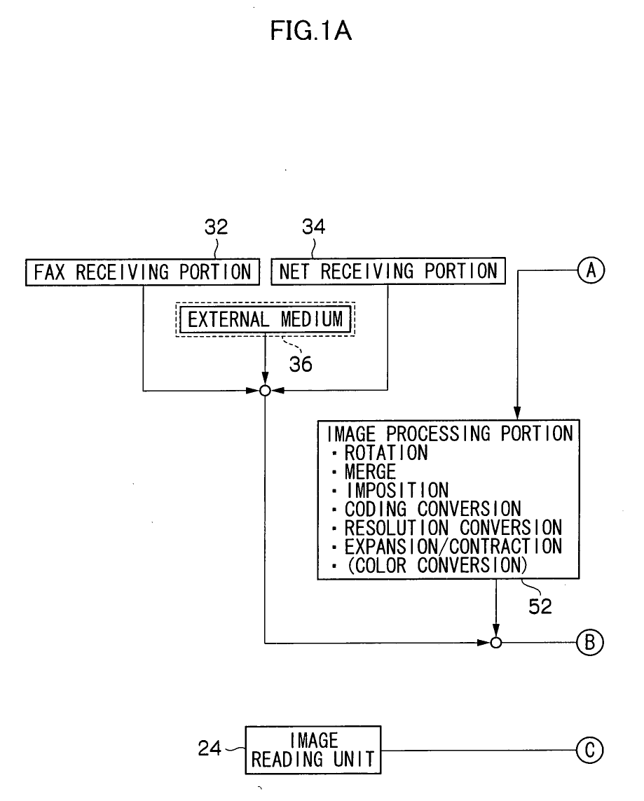

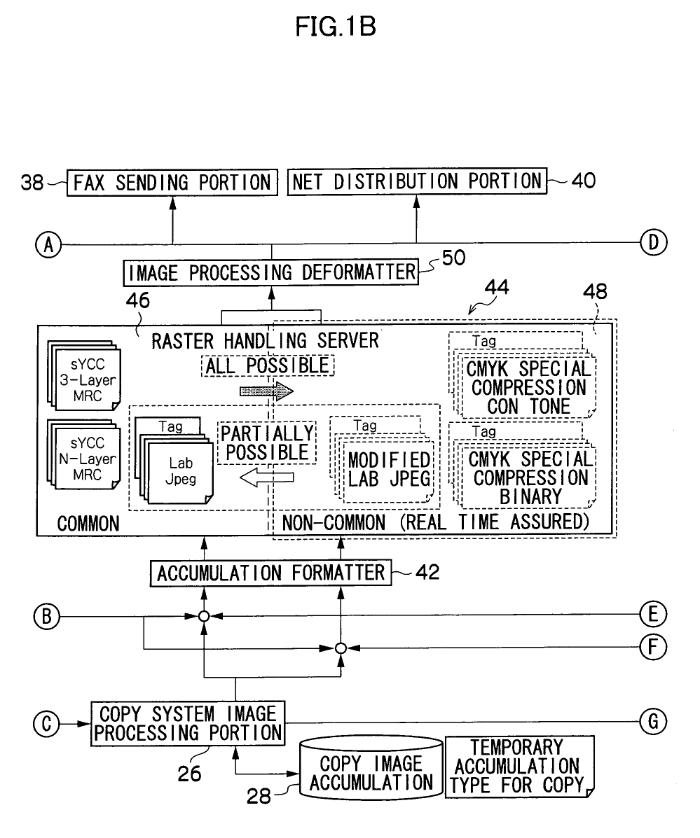

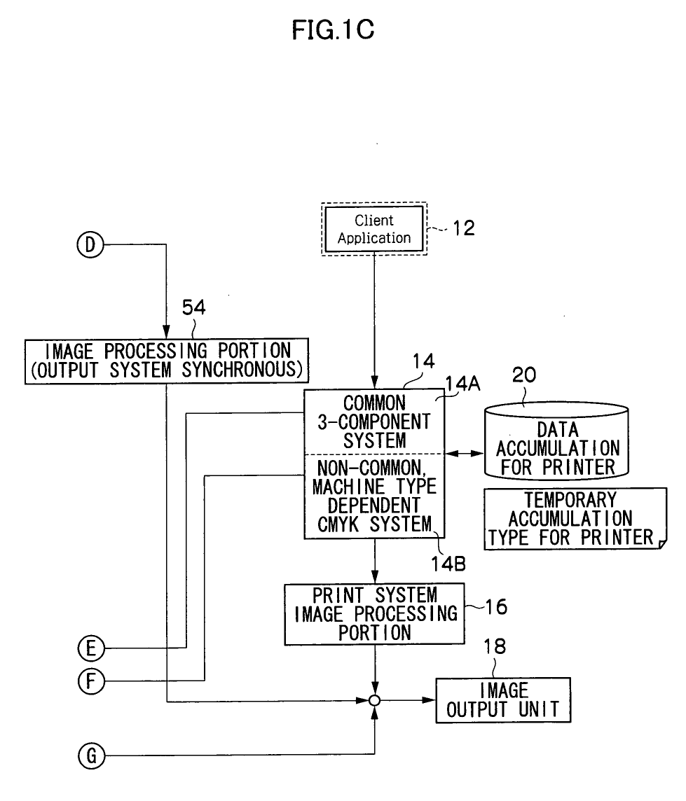

As shown in FIGS. 1A to 1C, the multi function printer as a data storage output apparatus of this embodiment includes multiple input components for inputting data of different format, namely, a facsimile receiving portion 32 for receiving data through a telephone line, Internet receiving portion 34 for receiving data through the Internet, reading input portion 36 for inputting data read from an external medium, an image reading unit 24 for inputting data read from an original document as a medium to be read and a receiving portion 12 for receiving data from a client.

The multi function printer of this embodiment includes output components for outputting data in different data formats, namely, a facsimile sending portion 38 for sending data through a telephone line and Internet distribution portion 40 for distributing data through Internet.

Further, the multi function printer of this embodiment includes a hard disk 44 having a first memory area 46 as a storage component for storing data in an intermediate format, which can be converted into the data format required by the respective facsimile sending portion 38 and the Internet distribution portion 40, and an image processing deformatter 50 as a conversion component which converts data stored in the first memory area 46 into a data format required by each of the facsimile sending portion 38 and the Internet distribution portion 40 and outputs to the facsimile sending portion 38 and the Internet distribution portion 40.

The multi function printer of this embodiment further comprises: an image output unit 18 as a print output component; a second storage area 48, provided on the hard disk 44 as a print output storage component for storing data in a print output requirement format as required by the image output unit 18; and, an image processing portion 52 as a conversion processing component, for converting data stored in the first memory area 46 into the print output requirement format to output it to the second storage area 48.

The second memory area 48 stores the aforementioned data in a compressed state. The multi function printer further includes an image processing portion 54 as a decompression component which decompresses data stored in a compressed state in the second memory area 48 and outputs it to the image output unit 18.

Data is stored in the second memory area 48 in the print output requirement format required by the image output unit 18. According to an aspect of the present invention, this data cannot be converted to the intermediate format. However, data stored in the second memory area 48 may contain data in the data format (modified LabJpeg described later) which can be converted to the intermediate format.

The image processing portion 52 converts data which is stored in the second memory area 48 and is able to be converted to the intermediate format into the intermediate format, and outputs the converted data to the first memory area 46.

The receiving portion 12 receives data of page-description language (PDL) format from a client. This multi function printer includes a decomposer 14 as a conversion output component which converts the data into the intermediate format or converts the data into the print output requirement format and outputs to the first memory area 46 and the second memory area 48.

The image reading unit 24 inputs data by reading a document. This multi function printer includes a copy system image processing portion 26 as a conversion processing output component and format conversion component. The conversion processing output component is capable of converting the inputted data into the intermediate format and outputting the converted inputted data in the intermediate format to the first memory area 46. The format conversion component is capable of converting the inputted data into the print output requirement format and outputting the converted inputted data in the print output requirement format to the second memory area 48.

The aforementioned intermediate format data can be inputted from the external medium. The facsimile sending portion 38 and the Internet distribution portion 40 send data through a telephone line and communication line such as Internet, respectively.

The data processing unit is constituted of the facsimile-receiving portion 32, the Internet receiving portion 34, the reading input portion 36, the image reading unit 24, the receiving portion 12, the decomposer 14 and the copy system image processing portion 26.

Next, a case where data inputted from each input portion is outputted to the image output unit 18 for print out will be described.

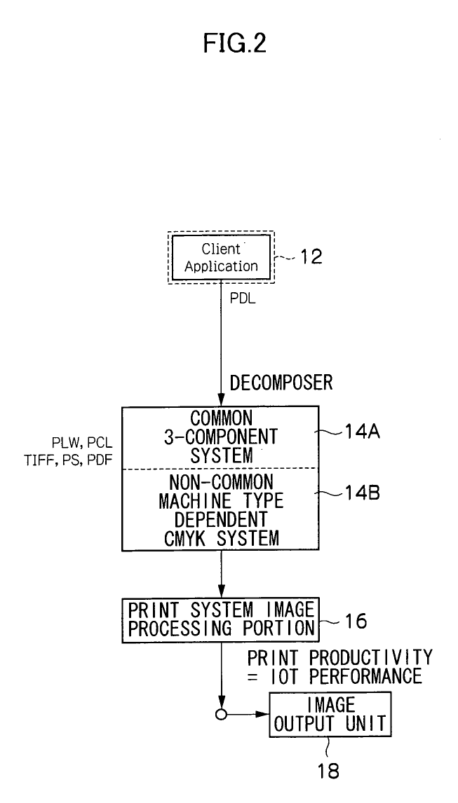

As shown in FIG. 2, data (that is, page-description language (PDL) which is generated by a client and sent to the multi function printer) received by the receiving portion 12 of this multi function printer is classified into first RGB three-color systems and second CMYK four-color systems. The RGB three-color systems include printer control language (PCL), specific printer description language (PLW) (FUJI XEROX specific description language for printers) and the like.

The CMYK four-color systems include tag image file format (TIFF), PDF file and the like, including post script (PS) and raster data.

Data of the various page-description language formats is converted to image data (print ready data) of a CMYK format by the decomposer 14, particularly a non-common, machine dependent CMYK system 14B and optimized by the printing system image processing portion 16 and after that, outputted to the image output unit 18 for print-out. In doing this, the non-common, machine dependent CMYK system 14B converts data of the page-description language format to image data of the CMYK format while optimizing to an image path provided, considering the image quality and communication efficiency.

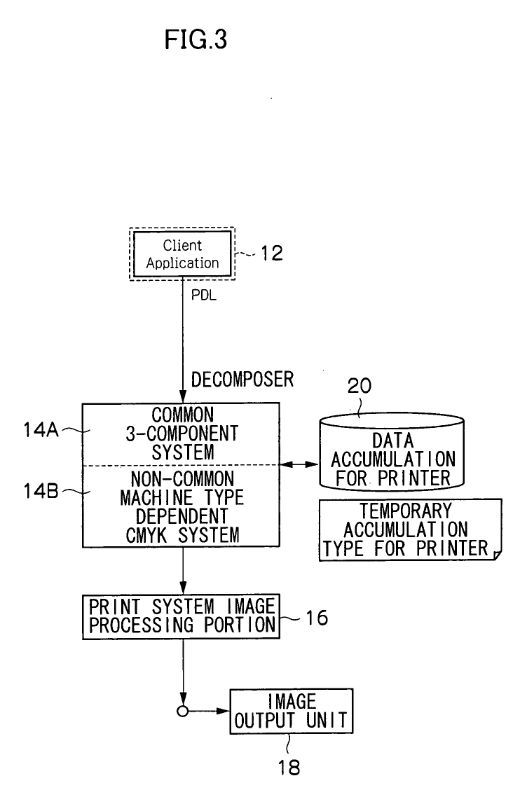

If a large quantity of prints are specified by a user, as shown in FIG. 3, the data converted by the decomposer 14 as described above is accumulated on a hard disk 20 for printer data accumulation and the data accumulated therein is outputted to the image output unit 18 through the printing system image processing portion 16 for print-out. A large quantity of prints can be executed rapidly without repeating decomposing.

Because this data is outputted through other output portions, the aforementioned accumulated data here (print ready data) is not converted to the intermediate format data, details of which will be described later, but is accumulated temporarily in order to output a large quantity of prints. The data format is optimized data format inherent of the image output unit 18.

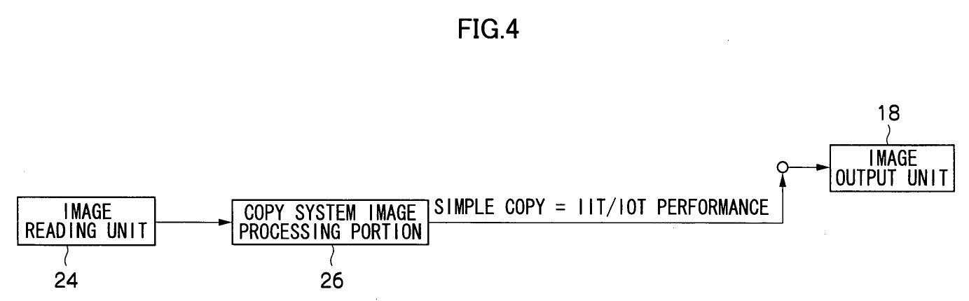

As shown in FIG. 4, the image data read by the image reading unit 24 of the multi function printer is optimized by the copy system image processing portion 26, processed into print ready data (CMYK format image data) and outputted to the image output unit 18.

That is, the copy system image processing portion 26 converts image data read by the image reading unit 24 to CMYK format image data in order to optimize to the image path provided, considering image quality and communication efficiency.

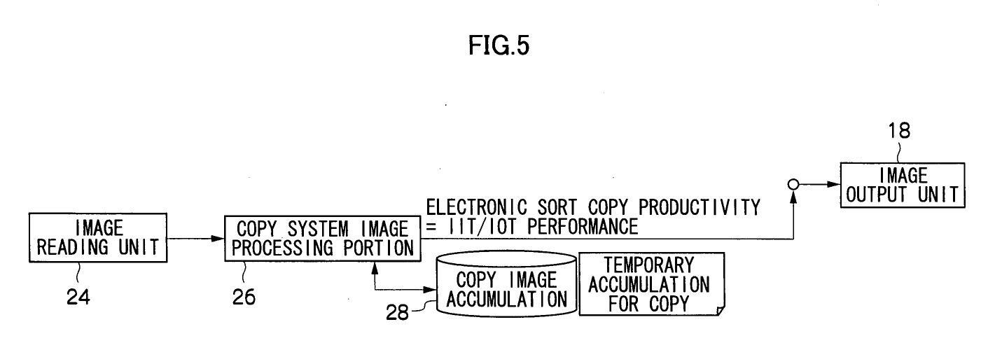

If printing of a large quantity is specified by a user, as shown in FIG. 5, image data optimized by the copy system image processing portion 26 is accumulated on a hard disk 28 for copy image accumulation and the data accumulated here is outputted to the image output unit 18 and printed out. Therefore, a large number of copies can be executed rapidly without repeating reading in of images for each of the copies.

In carrying this out, because data is outputted through another output portion described later, data accumulated in the hard disk 28 for copy image accumulation is not converted to any intermediate format data, the details of which will be described later, but is accumulated temporarily in order to output a large quantity. The data format is of an optimized data format specific to the image output unit 18.

The example described above indicates paths or the like for outputting data inputted from each input portion to the image output portion 18. However, data inputted from each input portion is not always outputted to the image output unit 18, but may be outputted through another output portion according to a user's selection. That is, processing procedure information that instructs the data processing procedure is inputted from each input portion and the inputted data is outputted to the image output unit 18 or through other output portions according to that inputted processing procedure information. Here, the processing procedure information may be, for example, an instruction document (instruction program indicating the processing procedure).

In this case, if the data inputted from each input portion were to be converted to the CMYK format image data or the like, it could not be outputted from portions different from the image output unit 18, such as through the facsimile sending portion 38 or the Internet distribution portion 40. This is because the facsimile sending portion 38 and the Internet distribution portion 40 cannot process data unless it is data of the format required by themselves.

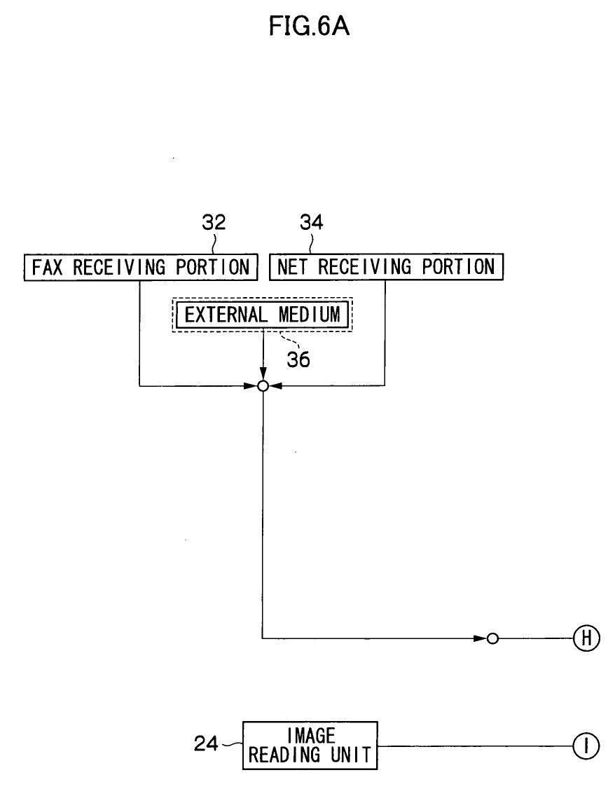

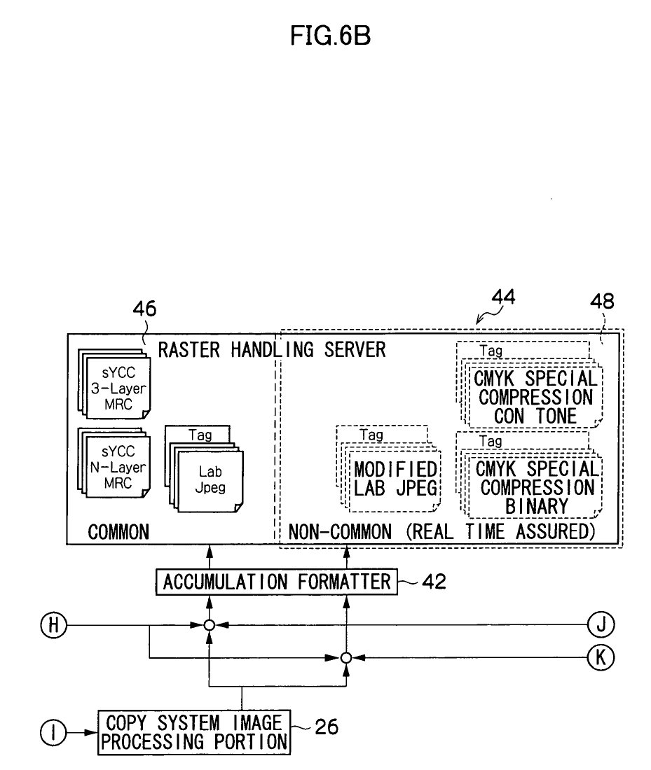

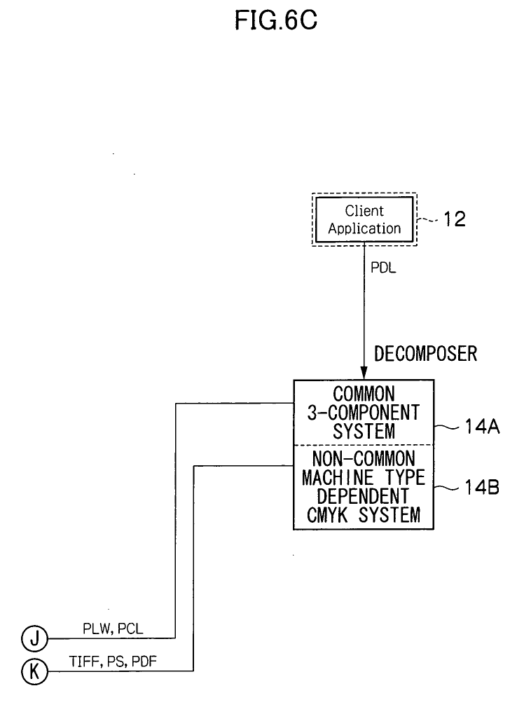

Thus, this embodiment includes a hard disk 44, which stores data inputted from each input portion in an intermediate format which can be converted to the data formats required by each of the facsimile sending portion 38 and the Internet distribution portion 40, according to the processing procedure information. The hard disk 44 has a first memory area 46 and a second memory area 48 as described above, and as shown in FIGS. 6A-6C. Data inputted from each input portion is stored in the first memory area 46 in the intermediate format. That is, data used in an external device or widely used data is handled as common data, and scan data composed of common data and print data from 3-component systems are stored as common data not dependent on any common machine type, similarly to the data from facsimile, Internet or external medium.

The second memory area 48 stores data in a non-common format dependent on the type of machine type. That is, because data for print (CMYK system)/copy server is print ready data and required to have both high image quality and high productivity. Commonality is sacrificed and this data is accumulated as machine dependent data, assured non common real time output data, in order to prioritize productivity and image quality.

Each case for storing the data inputted from each input portion, according to a user's instruction, in the aforementioned intermediate format will be described with reference to FIGS. 6A-6C.

Data (particularly the PCL and PLW of the PDL) received by the receiving portion 12 of this multi function printer is converted to the Lab Jpeg format, among the common formats, by a common 3-component system 14A of the decomposer 14, and this data is distributed to the first memory area 46 by an accumulation formatter 42 and stored.

On the other hand, the data received by the receiving portion 12 of this multi-function printer (particularly the aforementioned TIFF, PS, PDF of the PDL) is converted to the CMYK system data format by the non-common, machine dependent CMYK system 14B and compressed. This data is distributed to the second memory area 48 by the accumulation formatter 42 according to user's instruction and stored.

Next, the image data read by the image reading unit 24 of this multi function printer is converted to sYCC (Jpeg) format by the copy image processing portion 26, distributed to the first memory area 46 by the accumulation formatter 42, stored therein, or converted to modified LabJpeg format, and then distributed to the second memory area 48 by the accumulation formatter 42 and stored.

Data inputted by reading from an external medium by the reading input portion 36 is in sYCC (Jpeg) format and stored in the first memory area 46 as it is.

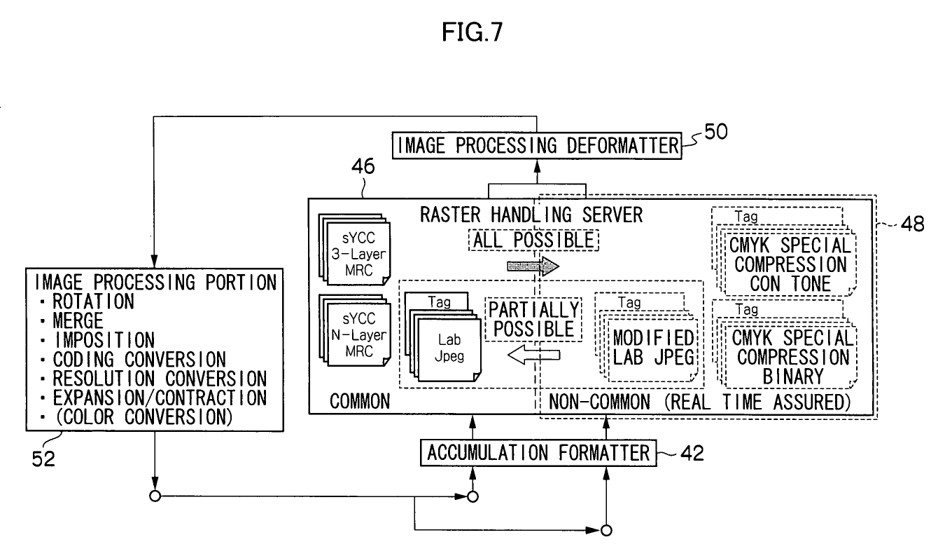

This embodiment permits user to give an instruction for converting data stored in the intermediate format in the first memory area 46 to a machine dependent, non common format to output to the second memory area 48. This embodiment includes an image-processing portion 52 for this purpose as shown in FIG. 7.

The second memory area 48 stores machine dependent, non-common format data and the data of such formats essentially cannot be converted to the intermediate format, though data of some formats can be converted to the intermediate format. Here, the image-processing portion 52 carries this out according to a user's instruction.

The image processing portion 52 can execute editing processing, including rotation merge, imposition, coding conversion, resolution conversion, expansion/contraction, color conversion and the like as well as the above-described processings.

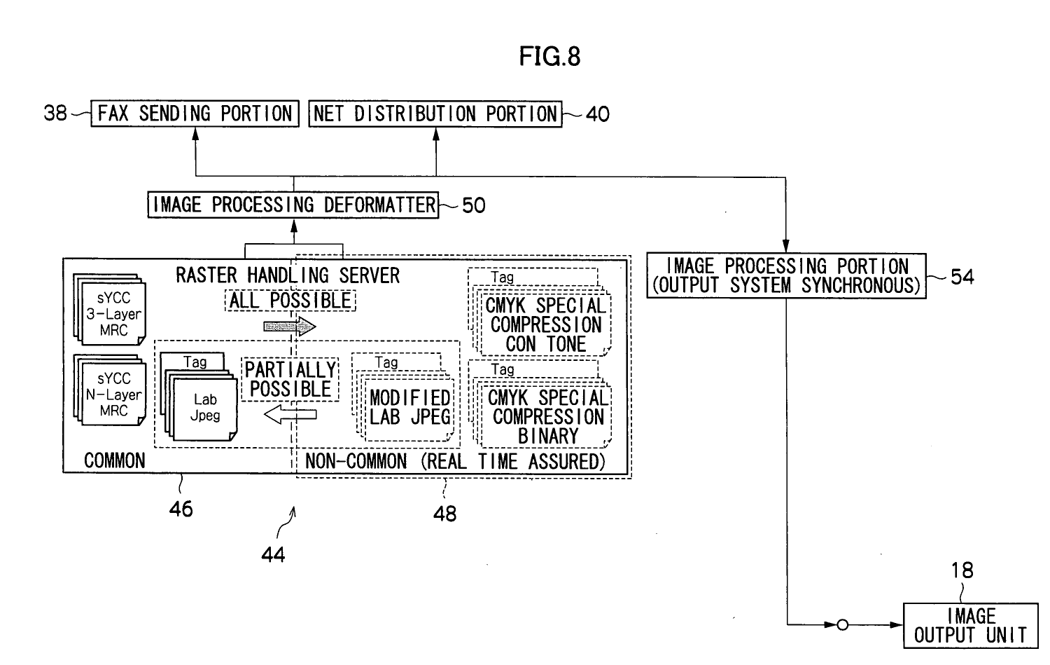

Next, output of data stored in the first memory area 46 and the second memory area 48 will be described with reference to FIG. 8.

Data stored in the first memory area 46 is converted to data format required by an output destination (facsimile sending portion 38, Internet distribution portion 40) by the image processing deformatter 50 and outputted to the facsimile sending portion 38 or the Internet distribution portion 40 corresponding to user's instruction.

If print processing is carried out based on data stored in the second memory area 48, data is outputted to the image output portion 18 by the image processing deformatter 50. Because the data stored in the second memory area 48 is stored in compressed state, the image-processing portion 54 decompresses the data stored in the second memory area 48 before outputting to the image output unit 18.

As for data stored in the second memory area 48, data stored in the first memory area 46 may be converted by the image-processing portion 52 and stored in the second memory area 48 (see FIG. 7).

Because according to this embodiment, as described above, data is stored in the first memory area 46 in the intermediate format, which can be converted to a data format required by an output destination (facsimile sending portion 38, Internet distribution portion 40), and the stored data is outputted after being converted to a data format corresponding to the output destination, the data can be outputted to any one of plural output destinations thereby increasing the degrees of freedom in data output styles.

This invention enables merging of print data and copy data, free editing, processing, accumulation and the like of various image information, inputted through Internet or external interfaces, to be carried out quickly and with high image quality. This was difficult conventionally.

By making the conventional image path coexist in this embodiment, specialized image information optimized for copying and printing can be secured at an unchanged image quality and productivity.

Further, this embodiment, being equipped with an image processing function for conventional image data, allows image data captured as general purpose common data to be printed out quickly in a large quantity, as print ready data.

According to the present invention, inputted data is stored in an intermediate format, which can be converted to a data format required by each of plural output components, and the stored data is converted to data formats corresponding to the output components and outputted. Therefore, the data can be outputted to any output component among the plural output components, thereby increasing the degrees of freedom in data output styles.

What is claimed is:

1. A data storage output apparatus comprising:
an input component that inputs data;
a plurality of output components that output data in different respective data formats;
a storage component that stores data in an intermediate format capable of being converted to a data format required by each of the plurality of output components; and
a conversion component that converts the data stored in the storage component to a data format corresponding to an output component and outputs the data to the output component.

2. The data storage output apparatus of claim 1, further comprising:
a print output component;
a print output storage component that stores data in a print output requirement format that is required by the print output component; and
a conversion processing component that converts the data stored in the storage component into the print output requirement format and outputs the data to the print output storage component.

3. The data storage output apparatus of claim 2, wherein
the print output storage component stores the data in a compressed state, and
the data storage output apparatus further
comprises a decompression processing component that decompresses the data stored in the print output storage component in compressed state and outputs the data to the print output component.

4. The data storage output apparatus of claim 2, wherein
the data stored in the print output storage component contains data of a data format capable of being converted into the intermediate format, and
the conversion processing component converts the data stored in the print output storage component and capable of being converted to the intermediate format to the intermediate format and outputs the data to the storage component.

5. The data storage output apparatus of claim 2, wherein
the input component inputs data of a page description language format,
the data storage output apparatus further
comprises a conversion output component capable of converting the page description language format data inputted by the input component to the intermediate format and outputting the data to the storage component, and, capable of converting the data to the print output requirement format and outputting the data to the print output storage component.

6. The data storage output apparatus of claim 2, wherein
the input component inputs data by reading from a medium, and
the data storage output apparatus further
comprises a conversion processing output component capable of converting the data obtained by the reading to the intermediate format and outputting the data to the storage component, and capable of converting the data to the print output requirement format and outputting the data to the print output storage component.

7. The data storage output apparatus of claim 1, wherein the input component inputs data from a storage medium storing the intermediate format data.

8. The data storage output apparatus of claim 1, wherein the output component outputs the data through a communication line.

9. The data storage output apparatus of claim 2, wherein a path for sending data inputted by the input component to the print output component is provided.

10. A data storage output method comprising:
(a) inputting data by an input component;
(b) storing in a storage component, data in an intermediate format capable of being converted to data formats required by respective output components that output data in different respective data formats; and
converting the data to a data format corresponding to an output component and outputting the data to the output component.

11. The data storage output method of claim 10 further comprising:
(d) storing in a print output storage component data in a print output requirement format that is required by a print output component; and
(e) converting the data stored in the storage component into the print output requirement format and outputting the data to the print output storage component by using a conversion processing component.

12. The data storage output method of claim 11, wherein
the print output storage component stores the data in a compressed state, and
the data storage output method further comprises:
(f) decompressing the data stored in the print output storage component in compressed state and outputting the data to the print output component by using a decompression processing component.

13. The data storage output method of claim 11, wherein
the data stored in the print output storage component contains data of a data format capable of being converted into the intermediate format, and
the data stored in the print output storage component and capable of being converted to the intermediate format is converted to the intermediate format and the data is outputted to the storage component by means of a conversion processing component.

14. The data storage output method of claim 11, wherein
the input component inputs data of a page description language format, and
the data storage output method further comprises:
(g) converting the page description language format data inputted by the input component to the intermediate format and outputting the data to the storage component, or converting the page description language format data to the print output requirement format and outputting the data to the print output storage component, by means of a conversion output component.

15. The data storage output method of claim 11, wherein
the input component inputs data by reading a medium to be read, and
the data storage output method further comprises:
(h) converting the data obtained by the reading to the intermediate format and outputting the data to the storage component, or converting the data obtained by the reading to the print output requirement format and outputting the data to the print output storage component, by a conversion processing output component.

16. The data storage output method of claim 10, wherein the input component inputs data from a storage medium storing the intermediate format data.

17. The data storage output method of claim 10, wherein the output component outputs the data through a communication line.

18. The data storage output method of claim 11, further comprising
(i) sending the data inputted by the input component to the print output component through a predetermined path.

19. A data processing apparatus comprising:
an input component that inputs image data and processing procedure information, for instructing about the processing procedure of the image data; and
a format converting component that, based on the inputted processing procedure information, converts the inputted image data to a data format that is required by an output component or to a format different therefrom.

20. The data processing apparatus of claim 19, wherein the different format is an intermediate format capable of being converted to the data format required by the output component.

21. A data processing method comprising:
inputting image data and processing procedure information, for instructing the processing procedure of the image data; and
converting, based on the inputted processing procedure information, the inputted image data to a data format that is required by an output component or to a different format therefrom.

22. The data processing method of claim 21, wherein the different format is an intermediate format capable of being converted to the data format that is required by the output component.
